(19) United States
(12) Patent Application Publication
(10) Pub. No.: US 2011/0033229 A1
(43) Pub. Date: Feb. 10, 2011

(54) DEVICE FOR DISCONNECTING AND RECONNECTING AUTOMATICALLY TWO ADJACENT LENGTHS OF AN ELONGATED MECHANICAL TRANSMISSION MEMBER, SUCH AS A PUSH-PULL CABLE, A ROD OR A BAR, PARTICULARLY FOR USE IN MOTOR VEHICLES

(75) Inventors: Cristiano Baudino, Cuneo (IT); Guiseppe Alpignano, Alpignano (IT)

Correspondence Address: SUGHRUE MION, PLLC, 2100 PENNSYLVANIA AVENUE, N.W., SUITE 800, WASHINGTON, DC, 20037, US

(73) Assignee: SILA HOLDING INDUSTRIALE S.P.A., NICHELINO, (Torino) (IT)

(21) Appl. No.: 12/989,026

(22) PCT Filed: Apr. 24, 2009
(86) PCT No.: PCT/IB09/51698

§ 371 Date: Oct. 21, 2010

(30) Foreign Application Priority Data
Apr. 24, 2008 (EP) 08425285.7

(51) Int. Cl. F16D 1/00

(52) U.S. Cl. 403/322.1

(57) ABSTRACT

The device includes first and second elements which are intended to be rigidly connected each to a respective length of an elongated mechanical transmission member, such as a push-pull cable, a rod or a bar, and are slidably arranged relative to each other in the axial direction of the transmission member. A locking member is radially movable between a locking position, in which it drivingly connects the two elements for translation with each other, and a unlocking position, in which it disconnects the two elements from each other, thereby making them free to translate relative to each other. A cam member is free to translate axially relative to the first and second elements and has at least one cam surface which cooperates with the respective locking member so as to keep this latter in the locking position up to the predetermined travel value and to move it into the unlocking position in case of travel values higher than the predetermined travel value.

The present invention refers generally to mechanisms for transmitting commands by means of elongated mechanical transmission members, such as push-pull cables, rods or bars, particularly for use in motor vehicles. More specifically, the present invention relates to a device for disconnecting automatically two adjacent lengths of an elongated mechanical transmission member when the travel exceeds a predetermined value, and for reconnecting automatically those lengths when the travel returns below that predetermined value.

The expression “elongated mechanical transmission member” is to be intended as referred, in the following description and claims, to any mechanical member able to transmit a command by means of a translational movement. Such a member may be either a flexible member (push-pull cable) or a rigid member (rod or bar). Moreover, the term “travel” refers, in the following description and claims, to the amount of the relative axial (that is to say, along the direction of the axis of the elongated mechanical transmission member) translational movement between the elongated mechanical transmission member and the casing of the automatic disconnection and reconnection device.

Devices are known which allow to disconnect and reconnect automatically two adjacent lengths of an elongated mechanical transmission member, such as a cable, a rod or a bar, the member being intended in particular to transmit the commands imparted by the driver from the gear shift lever of a motor vehicle to the actuating members of the gearbox of that vehicle when the travel of the transmission member is above or below a predetermined travel value, respectively. These known devices, however, are rather complicated, since they use toothed or ratchet gear mechanisms for releasable connection of the two adjacent lengths of the elongated mechanical transmission member with each other.

DE 25 22 641 discloses a control device for a gearbox of a tilt-cab vehicle, the control device comprising a gear shift lever, an elongated mechanical transmission member consisting of two telescopic tubes, that is to say, an outer tube and an inner tube, respectively, and a device for disconnecting automatically the two tubes when the cab is rotated from a normal driving position to a forwardly tilted position. The transmission member is connected to the gear shift lever by means of an articulation pin interposed between a fork element fixed to the lower end of the gear shift lever and a sleeve fixed to the outer tube. At an end of the inner tube a cylindrical element is fixed, which is received within the outer tube and is provided with a pair of teeth between which the articulation pin extends. The automatic disconnection device comprises a lifter which is carried by the outer tube so as to be pivotable between a locking position, in which it engages in a cavity of the cylindrical element thereby connecting the two tubes for translation with each other, and an unlocking position, in which it disengages from the cavity thereby disconnecting the two tubes from each other. A spring arranged between the lifter and the outer tube tends to keep the first one engaged in the cavity. The automatic disconnection device further comprises an actuating member which is fixed to the fork element and cooperates with the lifter, in such a manner that when the vehicle cab is tilted the actuating member rotates therewith and therefore causes the lifter to rotate from the locking position to the unlocking position.

The device known from DE 25 22 641 does not therefore allow to disconnect automatically the two lengths of the elongated mechanical transmission member each time the travel (according to the above-defined meaning) of the transmission member exceeds a predetermined given value, but only each time the actuating member, and hence the gear shift lever, is pivoted relative to the transmission member by an angle which is larger than a predetermined given value.

U.S. Pat. No. 6,390,722 discloses a device for disconnecting automatically two interconnected cable lengths when a given tensile force is exceeded. The device comprises a first element which is intended to be connected to a first cable length and is made as a cylindrical piston, and a second element which is intended to be connected to a second cable length. The second element is connected by means of a threaded connection to a collar, which is in turn connected by means of a threaded connection to a cylindrical hollow body within which the piston is slidably received. The piston comprises a portion having a reduced diameter, on which a guide bush is mounted which has a flange against which a spring insists, the spring being arranged coaxially with the piston and tending to urge the guide bush against an abutment surface of the collar. A plurality of balls are radially interposed between a circumferential groove of the portion of the piston having a reduced diameter and an inner flange of the collar. Until the tensile force transmitted through the two cable lengths is lower than the preload of the spring or, anyway, is such as to bring about a compression of the spring which is not large enough to disengage the balls from the groove of the piston, the two elements of the device, and hence the two cable lengths connected thereto, remain interconnected, although they can move axially relative to each other due to the deformation of the spring. On the other hand, when the tensile force exceeds a given maximum value, the compression of the spring is such that the balls disengage from the groove, thereby disconnecting the two elements, and hence the two cable lengths connected thereto.

The device known from U.S. Pat. No. 6,390,722 therefore causes the two lengths of an elongated transmission member to be disconnected from each other when a given maximum tensile force, not a given maximum travel, is exceeded. Moreover, the provision of a spring between the two movable elements of the device allows relative movements between the two elements even in the condition in which they are connected to each other, which prevents the device from being used in those applications which require a rigid connection, that is to say, a connection without relative movements, between the two lengths. A further drawback is that upon disconnection of the two movable elements when the maximum tensile force to which the device is set is exceeded, the two elements must be manually reconnected by the user.

It is therefore an object of the present invention to provide a device for disconnecting and reconnecting automatically two adjacent lengths of an elongated mechanical transmission member, in particular a member intended to transmit the commands imparted by the driver from the gear shift lever of a motor vehicle to the actuating members of the gearbox of that vehicle, which is simple, inexpensive and reliable in use and which is not affected by the drawbacks of the prior art discussed above.

This and other objects are fully achieved according to the present invention by virtue of a device having the characteristics defined in the characterizing part of the enclosed independent claim 1.

Further advantageous characteristics of the invention are specified in the dependent claims.

In short, the invention is based on the idea of interposing, between the two adjacent lengths of the elongated mechanical transmission member, a device arranged to disconnect and reconnect automatically the two lengths each time the travel of the transmission member is above or below a predetermined travel value, respectively, the device comprising:
a first element intended to be drivingly connected for translation with one of the two lengths of the transmission member and a second element intended to be drivingly connected for translation with the other length of the transmission member, said first and second elements being slidable relative to each other in the axial direction of the transmission member; and
cam-like releasable connection means arranged to keep the first and second elements drivingly connected with each other in the axial translational movement of the transmission member up to a predetermined travel value and to disconnect automatically those elements from each other once that predetermined travel value has been exceeded.

Preferably, said cam-like releasable connection means include:
a plurality of locking members which are radially movable between a locking position, in which they drivingly connect the two lengths of the transmission member for translation with each other, and an unlocking position, in which they disconnect the two lengths of the transmission member from each other, thereby making them free to translate relative to each other; and
a cam member which is free to translate relative both to the first and to the second element and which has at least one cam surface cooperating with the locking members so as to keep those members in the locking position up to a travel value equal to the predetermined travel value and to move those members into the unlocking position above the predetermined travel value.

More preferably, the first and second elements are made respectively as a sleeve-like element and as a rod-like element which is slidably mounted within the sleeve-like element, and the locking members are made as studs which are slidably mounted within respective radial through holes in the sleeve-like element and are adapted to engage, in the locking position, in respective notches provided on the lateral surface of the rod-like element. In this case, the cam surface has a first surface portion which extends axially and is placed at a smaller distance from the axis of the transmission member, a second surface portion which extends axially and is placed at a greater distance from the axis of the transmission member, and a third inclined surface portion which joins the first and second surface portions, in such a manner that the studs are kept in the locking position until they are in contact (with the interposition of balls or needles, if needed) with the first surface portion, whereas they move into the unlocking position and thus allow the two lengths of the transmission member to be disconnected from each other when they lose contact with the first surface portion and come into contact with the second surface portion.

According to a first embodiment, the cam member is intended to be fixed to a stationary part of the motor vehicle, for example a part of the support casing of the gear shift lever in case the device is mounted on the side of the passenger compartment. In this way, until the travel of the gear shift lever, and hence of the length of the transmission member connected thereto, is such that the studs cooperate with the first surface portion, the two lengths of the transmission member are drivingly connected for translation with each other and the transmission member is therefore able to transmit to the gearbox the commands imparted by the driver through the gear shift lever. On the contrary, as soon as the travel of the gear shift lever, and hence of the length of the transmission member connected thereto, exceeds the predetermined value, the studs lose contact with the first surface portion and therefore disconnect the two lengths of the transmission member from each other. When the travel is above the predetermined value, the longitudinal movements of the gear shift lever are not transmitted to the gearbox, as the two lengths of the transmission member are disconnected for translation from each other. In any case, as soon as the travel of the gear shift lever returns below the predetermined value, the studs come again into contact with the first surface portion (locking position), thereby reconnecting the two lengths of the transmission member for translation with each other. This solution is intended for cable or rod control systems for motor-vehicle transmissions in which the shift from/to some operating positions (for example from P to R and vice versa, in case of automatic transmissions) is controlled mechanically by means of the elongated mechanical transmission member (cable or rod), whereas the shift from/to other operating positions (for example from N to D and vice versa, in case of automatic transmissions) is controlled electronically by virtue of special sensors which detect the movement of the gear shift lever. It is therefore sufficient to set the predetermined travel value of the device according to the invention so that the device intervenes disconnecting automatically the two lengths of the transmission member from each other, and hence the gear shift lever from the gearbox, when the gear shift lever switches from the operating range corresponding to the mechanical transmission of the commands to the operating range corresponding to the electronic transmission of the commands.

According to a variant of embodiment, intended in particular for a gear shift control system for tilt-cab heavy vehicles, the cam member is intended to be fixed to a part which is drivingly connected with the cab, in such a manner that it causes automatically the two lengths of the transmission member (be it a cable or a rod) to be disconnected from each other when the cab is moved from the normal driving position to the tilted position and to be reconnected with each other when the cab is moved back into the normal driving position, the predetermined travel value of the transmission member being chosen in that case such that it is exceeded when the cab is moved from the normal driving position to the tilted position.

Further characteristics and advantages of the invention will become apparent from the following detailed description, given purely by way of non-limiting example with reference to the attached drawings, in which:

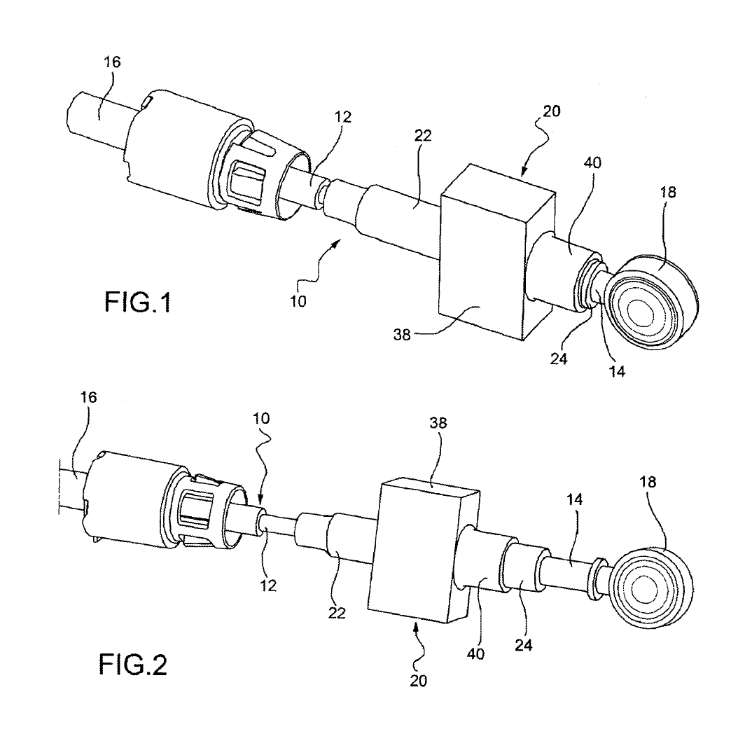

FIGS. 1 and 2 are perspective views of a device for disconnecting and reconnecting automatically two adjacent lengths of an elongated mechanical transmission member, such as a cable, a rod or a bar, according to a preferred embodiment of the present invention, in the connection position and in the disconnection position, respectively;

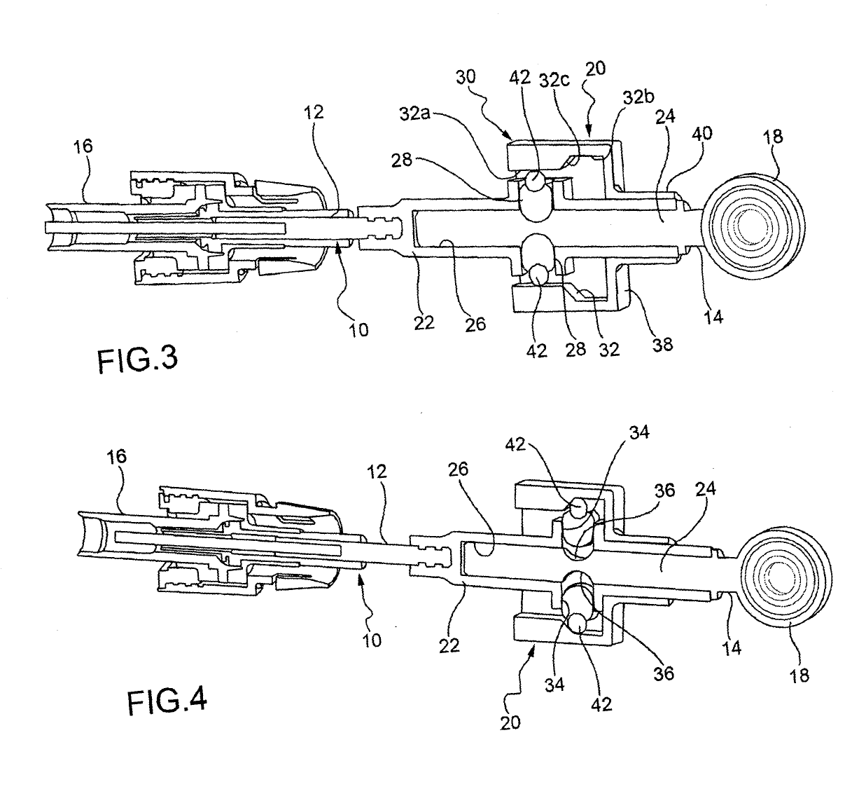

FIGS. 3 and 4 are cut-away views of the device of FIGS. 1 and 2, in the connection position and in the disconnection position, respectively;

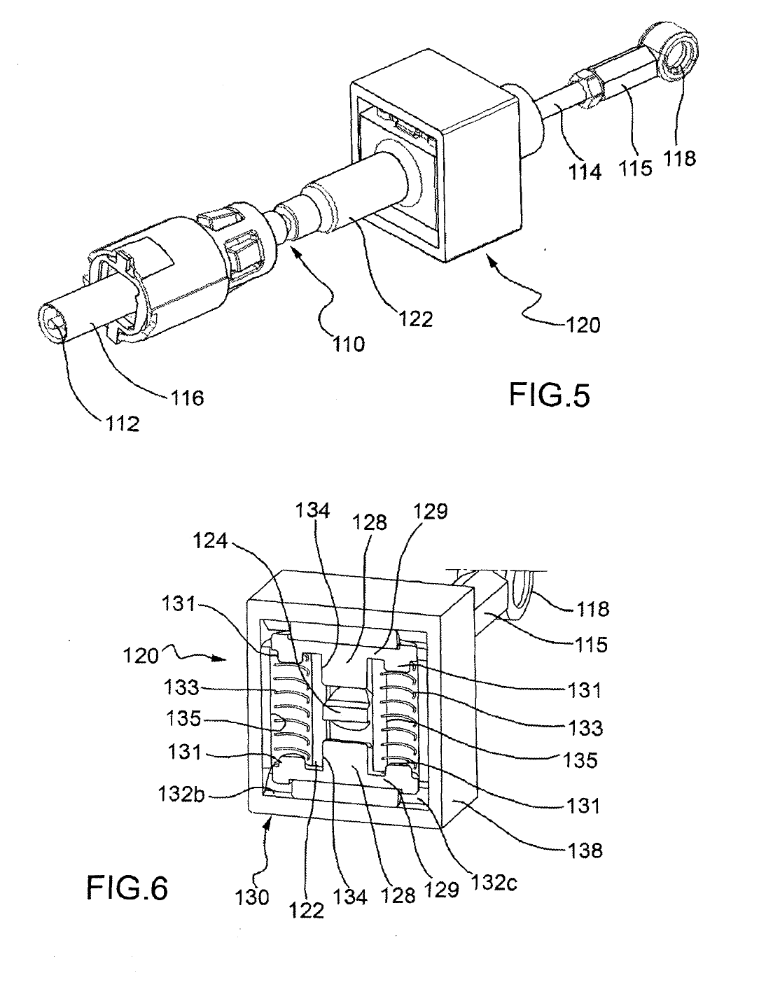

FIG. 5 is a perspective view of a device for disconnecting and reconnecting automatically two adjacent lengths of an elongated mechanical transmission member, such as a cable, a rod or a bar, according to a further preferred embodiment of the present invention;

FIG. 6 is a perspective view on an enlarged scale which shows the device of FIG. 5 sectioned through a plane perpendicular to the axis of the elongated mechanical transmission member;

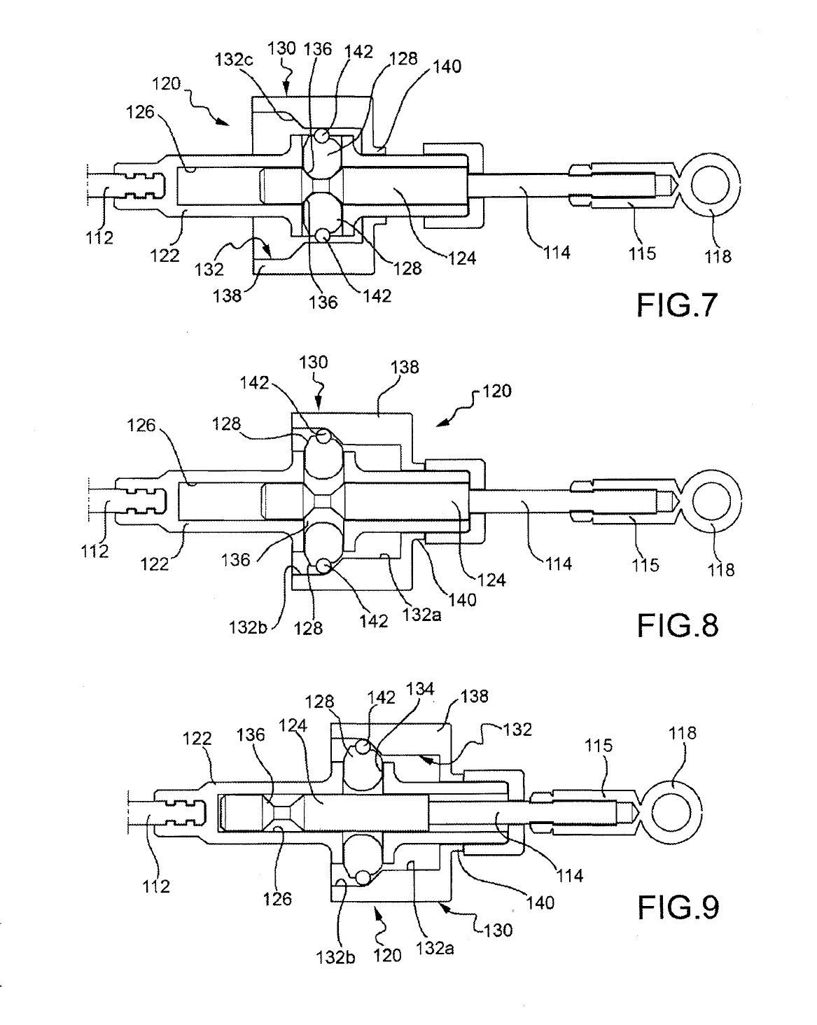

FIG. 7 is an axial section view which shows the device of FIG. 5 in the connection position; and

FIGS. 8 and 9 are axial section views which both show the device of FIG. 5 in the disconnection position and which differ from each other in the travel value of the elongated mechanical transmission member.

The following description will be given with specific reference to the application of the automatic connection/disconnection device to an elongated mechanical transmission member consisting of a push-pull cable and intended to transmit commands from a gear shift lever of a motor vehicle to the gearbox of that vehicle. It is however clear that the invention can be also applied to any other type of elongated mechanical transmission member, such as for example a rod, as well as to any other type of control system which provides for the use of elongated mechanical transmission members for the transmission of commands from a control member to an actuating member.

With reference first to FIGS. 1 to 4, an elongated mechanical transmission member, which is made in the present embodiment as a push-pull cable, is generally indicated 10 and includes a first core length 12, a second core length 14 separate from the first one and a sheath 16 into which the first core length 12 is slidably inserted. In the illustrated embodiment, the second core length 14 consists of a rigid end portion of the transmission member 10 and is provided at its end with a ball-joint head 18 in which a ball pin (not shown) of a gear shift lever (also not shown) is engageable. An automatic disconnection and reconnection device, generally indicated 20, is interposed between the two core lengths 12 and 14.

The device 20 includes first of all a first element 22 drivingly connected for translation with the first core length 12 and a second element 24 drivingly connected for translation with the second core length 14 (made in a single piece with the second core length 14 in the illustrated example). The first element 22 and the second element 24 are slidably mounted relative to each other in the axial direction of the transmission member 10, hereinafter simply referred to as axial direction. More specifically, the first element 22 is made in the shape of a sleeve and has an inner cylindrical hole 26 extending in the axial direction, whereas the second element 24 is made in the shape of a cylindrical rod and is slidably mounted within the hole 26 of the first element 22.

The device 20 further includes cam-like releasable connection means arranged to keep the two elements 22 and 24 drivingly connected with each other in the axial translational movement of the transmission member 10 up to a predetermined travel value. The cam-like releasable connection means are arranged to disconnect automatically the two elements 22 and 24 once the predetermined travel value has been exceeded and to reconnect automatically the two elements 22 and 24, thereby making them again drivingly connected with each other in the axial translational movement of the transmission member 10, as soon as the travel returns below the predetermined travel value.

More specifically, these cam-like releasable connection means include a plurality (two, in the illustrated embodiment) of locking members 28 movable in the radial direction (i.e. in a direction perpendicular to the axial direction) between a locking position (FIG. 3), in which they drivingly connect the two elements 22 and 24, and hence the two core lengths 12 and 14, for translation with each other, and an unlocking position (FIG. 4), in which they disconnect the two elements 22 and 24, and hence the two core lengths 12 and 14, from each other, thereby making them free to translate relative to each other. These cam-like releasable connection means further include a cam member 30 which is free to translate relative both to the first and to the second element and has a corresponding plurality of cam surfaces 32 each cooperating with a respective locking member 28 so as to keep the locking member 28 in the locking position up to a travel value of the transmission member 10 equal to the predetermined travel value and to move the locking member 28 into the unlocking position when the travel value exceeds the predetermined travel value.

In the illustrated embodiment, the locking members 28 are made as studs slidably mounted into respective radial through holes 34 of the first element 22 and are arranged to engage, in the locking position, in respective notches 36 provided on the lateral surface of the second element 24. In the illustrated embodiment, the axial section of the notches 36 is shaped as an arc of circumference, but may of course have any other shape, such as for example a triangular or trapezoidal shape. The radially inner ends of the studs 28 advantageously have an axial section the shape of which is complementary to that of the notches 36, so as to ensure a perfect mating of two elements 22 and 24 when the studs 28 are in the locking position.

The cam member 30 is made as a hollow piece which is separate both from the first element 22 and from the second element 24 and comprises a main body 38 of parallelepiped shape and a guide cylindrical portion 40, which is preferably formed in a single piece with the body 38 and is guided on the outer cylindrical surface of the second element 24. Each of the cam surfaces 32 (two surfaces in the illustrated example, i.e. one for each stud 28, arranged on opposite sides of the axis of the transmission member 10) has a first surface portion 32a placed at a smaller distance from the axis of the transmission member 10, a second surface portion 32b placed at a greater distance from the axis of the transmission member 10, and a third surface portion 32c which joins the first and second surface portions. In the illustrated embodiment, the first and second surface portions 32a and 32b are flat surfaces and extend parallel to the axis of the transmission member 10, whereas the third surface portion 32c is also a flat surface but extends obliquely relative to the axis of the transmission member 10.

According to an alternative embodiment (not illustrated), the main body of the cam member has an axially symmetrical configuration with respect to the axis of the transmission member. In such a case, the first and second surface portions of the cam surface are cylindrical surfaces of smaller and greater diameter, respectively, whereas the third surface portion is a frustoconical surface.

A ball (or alternatively a needle) 42 is interposed between each stud 28 and the respective cam surface 32 and serves to reduce the friction between the stud 28 and the cam member 30 when these two components slide relative to each other. The studs 28 are kept in the locking position, in which they engage in the respective notches 36 and thus ensure that the two elements 22 and 24, i.e. the two core lengths 12 and 14, are connected with each other, until they slide along the respective first surface portions 32a (FIG. 3). The two core lengths 12 and 14 remain therefore rigidly connected with each other, and can thus ensure the mechanical transmission of the commands from the gear shift lever to the gearbox, up to a predetermined travel value equal at the most to the axial size of the first surface portion 32a. In case of higher travel values (FIG. 4), the studs 28 loose contact with the respective first surface portions 32a and come in contact with the respective second surface portions 32b, thereby moving into the unlocking position and causing the two elements 22 and 24, i.e. the two core lengths 12 and 14, to be disconnected from each other. The transmission member 10 is therefore no more able to transmit the commands from the gear shift lever to the gearbox. The shift of the studs 28 from the unlocking position to the locking position, which takes place automatically when the travel of the transmission member 10 returns below the predetermined travel value, is made easier by the inclination of the third surface portion 32c.

In case the device 20 for disconnecting and reconnecting automatically an elongated mechanical transmission member is intended to transmit the commands from the gear shift lever of a motor vehicle to the gearbox of that vehicle, the cam member 30 will be fixed to a stationary part of the vehicle, for example to a part of the support casing of the gear shift lever. In this way, until the travel of the gear shift lever, and hence of the first length 12 connected thereto, is such that the studs 28 cooperate with the first surface portion 32a, the two lengths 12 and 14 of the transmission member 10 are drivingly connected for translation with each other and therefore the transmission member 10 is able to transmit to the gearbox the commands imparted by the driver through the gear shift lever. On the contrary, as soon as the travel of the gear shift lever exceeds the predetermined value, the studs 28 loose contact with the first surface portion 32a and therefore disconnect the two lengths 12 and 14 of the transmission member 10 from each other. In case of travel values higher than the predetermined one, the longitudinal movements of the gear shift lever are not transmitted to the gearbox, as the two lengths 12 and 14 of the transmission member 10 are disconnected for translation from each other. In any case, as soon as the travel of the gear shift lever returns below the predetermined value, the studs 28 automatically come into contact again with the first surface portion 32a (locking position), thereby rigidly reconnecting the two lengths 12 and 14 of the transmission member for translation with each other. Such a solution is indicated for cable or rod control systems for motor vehicle transmissions in which the shift from/to some operating positions (for example from P to R and vice versa, in case of automatic transmissions) is controlled mechanically by means of the elongated mechanical transmission member (cable or rod), whereas the shift from/to other operating positions (for example from N to D and vice versa, in case of automatic transmissions) is controlled electronically by virtue of special sensors which detect the tilting movement, typically in the axial direction, of the gear shift lever. It is therefore sufficient to set the predetermined travel value of the device according to the invention so that the device intervenes disconnecting automatically the two lengths of the transmission member from each other, and hence the gear shift lever from the gearbox, when the gear shift lever switches from the operating range corresponding to the mechanical transmission of the commands to the operating range corresponding to the electronic transmission of the commands.

The automatic disconnection and reconnection device according to the invention can also be used for example to transmit the commands from the gear shift lever to the gearbox in a tilt-cab heavy vehicle in order to allow the cab to be tilted without causing breakages in the elongated mechanical transmission member (or in the elongated mechanical transmission members) and/or in the components of the transmission system connected thereto. In such a case, the cam member will be fixed to a part which is drivingly connected with the cab, in such a manner as to cause the two lengths of the transmission member both to be automatically disconnected from each other when the cab is moved from the normal driving position to the tilted position and to be reconnected with each other when the cab is brought back into the normal driving position.

A second preferred embodiment of a disconnection and reconnection device for an elongated mechanical transmission member is illustrated in FIGS. 5 to 9, where parts and elements identical or corresponding to those of FIGS. 1 to 4 have been given the same reference numerals, increased by 100.

With reference to FIGS. 5 to 9, an elongated mechanical transmission member is generally indicated 110 and includes a first core length 112, a second core length 114 separate from the first one and a sheath 116 into which the first core length 112 is slidably inserted. The second core length 114 is drivingly connected for translation with a rigid end portion 115 of the transmission member 110 provided with a ball-joint head 118 for engaging a ball pin (not shown) of a control member (also not shown), such as a gear shift lever. An automatic disconnection and reconnection device, generally indicated 120, is interposed between the two core lengths 112 and 114.

The device 120 includes a first element 122 drivingly connected for translation with the first core length 112 and a second element 124 drivingly connected for translation with the second core length 114 (made in a single piece with the second core length 114 in the illustrated example). The first element 122 and the second element 124 are slidably mounted relative to each other in the axial direction of the transmission member 110, hereinafter simply referred to as axial direction. More specifically, the first element 122 is made in the shape of a sleeve and has an inner cylindrical hole 126 extending in the axial direction, whereas the second element 124 is made in the shape of a cylindrical rod and is slidably mounted within the hole 126 of the first element 122.

The device 120 further includes cam-like releasable connection means arranged to keep the two elements 122 and 124 drivingly connected with each other in the axial translational movement of the transmission member 110 up to a predetermined travel value. The cam-like releasable connection means are arranged to disconnect automatically the two elements 122 and 124 from each other once the travel value exceeds the predetermined travel value and to reconnect automatically the two elements 122 and 124, thereby making them drivingly connected with each other in the axial translational movement of the transmission member 110, as soon as the travel value returns below the predetermined travel value.

More specifically, these cam-like releasable connection means include a plurality (two, in the illustrated embodiment) of locking members 128 movable in the radial direction (i.e. in a direction perpendicular to the axial direction) between a locking position (FIG. 7), in which they drivingly connect the two elements 122 and 124, and hence the two core lengths 112 and 114, for translation with each other, and an unlocking position (FIGS. 8 and 9), in which they disconnect the two elements 122 and 124, and hence the two core lengths 112 and 114, from each other, thereby making them free to translate relative to each other. These cam-like releasable connection means further include a cam member 130 which is free to translate relative both to the first and to the second element and has a corresponding plurality of cam surfaces 132 cooperating each with a respective locking member 128 so as to keep the locking member 128 in the locking position up to a travel value of the transmission member 110 equal to the predetermined travel value and to move the locking member 128 into the unlocking position in case of a travel value greater than the predetermined travel value.

In the illustrated embodiment, the locking members 128 are made as studs slidably mounted within respective radial through holes 134 of the first element 122 and are arranged to engage, in the locking position, in respective notches 136 provided on the lateral surface of the second element 124. In the illustrated embodiment, the notches 136 have an axial section of trapezoidal shape, but may of course have any other shape, such as for example the shape of a triangle or of an arc of circumference. The radially inner ends of the studs 128 advantageously have an axial section with a shape complementary to that of the notches 136, so as to ensure a perfect mating of the two elements 122 and 124 when the studs 128 are in the locking position.

As can be seen in the cut-away view of FIG. 6, each stud 128 is provided at its radially outer end with a transverse bar 129 having at each end a retaining projection 131 for a respective spring 133, which is made as a cylindrical helical spring in the illustrated example. The two springs 133 are interposed each between the two transverse bars 129 of the two studs 128 so as to tend to move these latter away from each other, thereby disengaging them from the respective notches 136 in the second element 124. The two springs 133 are received each within a respective cylindrical hole 135 parallel to the holes 134 in which the studs 128 are slidably mounted.

The cam member 130 is made as a hollow piece which is separate both from the first element 122 and from the second element 124 and comprises a main body 138 of parallelepiped shape and a guide cylindrical portion 140, which is preferably formed in a single piece with the body 138 and is guided on the outer cylindrical surface of the second element 124. Each of the cam surfaces 132 (two surfaces in the illustrated example, i.e. one for each stud 128, which are arranged on opposite sides of the axis of the transmission member 110) has a first surface portion 132a placed at a smaller distance from the axis of the transmission member 110, a second surface portion 132b placed at a greater distance from the axis of the transmission member 110, and a third surface portion 132c which joins the first and second surface portions. In the illustrated embodiment, the first and second surface portions 132a and 132b are flat surfaces and extend parallel to the axis of the transmission member 110, whereas the third surface portion 132c is also a flat surface but extends obliquely relative to the axis of the transmission member 110.

A ball (or alternatively a needle) 142 is interposed between each stud 128 and the respective cam surface 132 and serves to reduce the friction between the stud 128 and the cam member 130 when these two components slide relative to each other. The studs 128 are kept in the locking position, in which they engage in the respective notches 136 and thus ensure that the two elements 122 and 124, i.e. the two core lengths 112 and 114, are connected with each other, until they slide along the respective first surface portions 132a (FIG. 7). The two core lengths 112 and 114 remain therefore rigidly connected to each other and can thus ensure the mechanical transmission of the commands from the gear shift lever to the gearbox up to a predetermined travel value equal at the most to the axial size of the first surface portion 132a. In case of higher travel values (FIG. 8), the studs 128 loose contact with the respective first surface portions 132a and come into contact with the respective second surface portions 132b, thereby moving into the unlocking position and causing the two elements 122 and 124, i.e. the two core lengths 112 and 114, to be disconnected from each other. The transmission member 110 is therefore no more able to transmit the commands from the gear shift lever to the gearbox. As can be seen in the view of FIG. 9, in fact, a further movement (to the left, with respect to a person observing that figure) of the gear shift lever, and hence of the second core length 114, does not result in any movement of the first core length 112, and hence of the actuating member controlled by it. The shift of the studs 128 from the unlocking position to the locking position, which takes place automatically when the travel of the transmission member 110 returns below the predetermined travel value, is made easier by the inclination of the third surface portion 132c.

As far as the mounting of the member 130 is concerned, what has been previously said with reference to the embodiment of FIGS. 1 to 4 still applies.

Naturally, the principle of the invention remaining unchanged, the embodiments and constructional details may vary widely with respect to those described and illustrated purely by way of non-limiting example.

For example, the locking members might be simply formed by balls arranged to be moved between a locking position, in which they are interposed between the inner and outer elements of the device, thereby connecting for translation these two components with each other, and an unlocking position, in which they are disengaged from the inner element and are interposed between the outer element and the cam member (advantageously formed in this case as an axially symmetrical hollow body arranged coaxially and outwardly of the outer element), in such a manner that the outer element is disconnected from the inner element.

1. A device for disconnecting and reconnecting two adjacent lengths of an elongated mechanical transmission member, such as a push-pull cable, a rod or a bar, the device comprising:
first and second elements intended to be rigidly connected each to a respective length of the transmission member, said first and second elements being slidable relative to each other in the axial direction of the transmission member; and
cam-like releasable connection means interposed between the first and second elements;
characterized in that said cam-like releasable connection means are arranged to keep the first and second elements drivingly connected for axial translation with each other up to a predetermined travel value, as well as to disconnect and reconnect automatically the first and second elements each time the travel of the transmission member exceeds or returns below said predetermined travel value, respectively.

2. Device according to claim 1, wherein said cam-like releasable connection means include
at least one locking member radially movable between a locking position, in which it drivingly connects the two elements for translation with each other, and an unlocking position, in which it disconnects the two elements from each other, thereby making them free to translate relative to each other; and
a cam member which is free to translate axially relative to the first and second elements and has at least one cam surface cooperating with said at least one locking member so as to keep this latter in the locking position up to said predetermined travel value and to move it into the unlocking position in case of travel values higher than said predetermined travel value.

3. Device according to claim 2, wherein the first element is made as a sleeve and the second element is made as a rod and is slidably mounted within the first element.

4. Device according to claim 3, wherein said at least one locking member is made as a stud slidably mounted within a respective radial through hole of the first element and is arranged to engage, in the locking position, in a respective notch provided on the lateral surface of the second element.

5. Device according to any of claim 2, wherein said at least one cam surface has first and second surface portions which extend axially and are placed at a smaller and at a greater distance, respectively, from the axis of the transmission member, and a third surface portion which joins the first and second surface portions, in such a manner that said at least one locking member is kept in the locking position until it abuts against the first surface portion, whereas it is kept in the unlocking position, thereby allowing the two lengths of the transmission member to be disconnected from each other, when it abuts against the second surface portion.

6. Device according to claim 2, wherein the cam member is made as a hollow piece which is separate from the first and second elements and comprises a main body having said at least one cam surface and a guide portion guided on the outer surface of the second element.

7. Device according to claim 6, wherein the main body and the guide portion are made in a single piece.

8. Device according to claim 6, wherein the main body has a substantially parallelepiped configuration.

9. Device according to claim 8, comprising two cam surfaces and two locking members arranged on opposite sides of the axis of the transmission member.

10. Device according to claim 8, wherein the first and second surface portions are flat surfaces and extend parallel to the axis of the transmission member and wherein the third surface portion is a flat surface and extends obliquely to the axis of the transmission member.

11. Device according to claim 2, wherein a rolling body is interposed between said at least one locking member and the respective cam surface.

12. A system for controlling a gearbox of a motor vehicle, comprising a gear shift lever and at least one elongated mechanical transmission member for transmitting to the gearbox the commands imparted by the driver through the gear shift lever, characterized in that it comprises, for each transmission member, a device according to claim 1.
